(19) United States
(12) Patent Application Publication
(10) Pub. No.: US 2003/0211228 A1
(43) Pub. Date: Nov. 13, 2003

(54) Process and system for forming pieces of meat or meat analogs

(76) Inventors: Arthur Ballard, Westport, ME (US); John W. DeMarco, Jacobstown, NJ (US); James W. Lamkey, Yardley, PA (US); Guro Jevne, Lier (NO)

Correspondence Address: Patent Administrator,, FMC Corporation, 1735 Market Street, Philadelphia, PA, 19103, US

(21) Appl. No.: 10/379,453

(22) Filed: Mar. 4, 2003

Related U.S. Application Data
(60) Provisional application No. 60/361,676, filed on Mar. 5, 2002.
(60) Provisional application No. 60/408,190, filed on Sep. 3, 2002.
(60) Provisional application No. 60/446,904, filed on Feb. 12, 2003.

(51) Int. Cl. A23L 1/31

(52) U.S. Cl. 426/641

(57) ABSTRACT

A preferred process for forming texturized pieces of a meat or meat-analog product includes mixing animal protein, vegetable protein, or a mixture thereof with alginate, sodium tripolyphosphate, and water, thereby forming an initial mixture, and mixing the initial mixture with calcium sulfate, thereby forming a secondary mixture. A preferred process also includes introducing a calcium-chloride solution to the secondary mixture, thereby forming a tertiary mixture, shaping the tertiary mixture into pre-formed pieces, and tumbling the pre-formed pieces to form the texturized pieces.

This application claims priority under 35 U.S.C. § 119(e) to U.S. provisional patent applications serial No. 60/361,676, filed Mar. 5, 2002, and serial No. 60/408,190, filed Sep. 3, 2002, and U.S. provisional patent application titled “Process for Forming Pieces of Meat and Meat Analogs,” filed Feb. 12, 2003 under Express Mail Label No. EV 160974585 US and identified as Attorney Docket No. FCI-1231, each of which is hereby incorporated by reference in its entirety.

### FIELD OF THE INVENTION

The present invention relates to meat processing. More particularly, the invention relates to meat-processing operations and equipment for producing texturized pieces of a meat or meat-analog product.

### BACKGROUND OF THE INVENTION

Pieces of meat and meat-analogs, e.g., vegetable proteins, for use in soups and pet foods are commonly formed using a steam tunnel. More particularly, the meat or meat-analog product is pulverized, formed into a desired shape with or without the use of a gelling agent, and then steamed in a steam tunnel to permanently set the shape.

A typical steam tunnel occupies a relatively large amount of floor space in the meat-processing plant, has high operating and maintenance costs, and requires a high capital investment. Moreover, a typical steaming process can generate approximately three-percent to six-percent waste, and scrap material that has been steamed is generally unsuitable for reprocessing.

The steamed pieces of meat or meat-analog product produced by the above-noted process can subsequently be combined with other solid or liquid materials, e.g., soup bases and gravies, and can be retorted or canned.

Virtually any type of meat or meat-analog product, including low-value meat-by-products, mechanically de-boned meat, and vegetable proteins, can be steamed in the above-noted manner. Pieces of meat or meat analogs formed by steaming usually have a homogenous appearance. A non-homogenous, fibrous appearance that approximates the appearance of whole muscle, however, is usually desired, particularly in products formed from lower-value meats and vegetable proteins.

Consequently, a need exists for a process and a system for producing texturized pieces of a meat or meat-analog product without the use of a steam tunnel.

### SUMMARY OF THE INVENTION

A preferred process for forming texturized pieces of a meat or meat-analog product comprises mixing animal protein, vegetable protein, or a mixture thereof with alginate, sodium tripolyphosphate, and water, thereby forming an initial mixture, and mixing the initial mixture with calcium sulfate, thereby forming a secondary mixture. A preferred process also comprises introducing a calcium-chloride solution to the secondary mixture, thereby forming a tertiary mixture, shaping the tertiary mixture into pre-formed pieces, and tumbling the pre-formed pieces to form the texturized pieces.

A preferred embodiment of a system for forming texturized pieces of a meat or meat-analog product comprises a first mixer for receiving animal protein, vegetable protein, or a mixture thereof, and alginate, sodium tripolyphosphate, and water and producing an initial mixture comprising same. A preferred embodiment also comprises a second mixer mechanically coupled to the first mixer for receiving the initial mixture, mixing the initial mixture with calcium-sulfate, and producing a secondary mixture comprising same.

A preferred embodiment further comprises an injector mechanically coupled to the second mixer for receiving the secondary mixture, introducing a calcium-chloride solution to the secondary mixture, and producing a tertiary mixture comprising same, and a texturizer-separator for tumbling pre-formed pieces formed from the tertiary mixture thereby forming the texturized pieces.

A preferred process comprises shaping a mixture of animal protein, vegetable protein, or a mixture thereof, and alginate, sodium tripolyphosphate, water, calcium sulfate, and calcium-chloride solution into pre-formed pieces, and tumbling the pre-formed pieces.

Another preferred process for forming texturized pieces of a meat or meat-analog product comprises mixing animal protein, vegetable protein, or a mixture thereof with a gelling agent, a sequestrant, and water, thereby forming an initial mixture, and mixing the initial mixture with a sparingly soluble source of multivalent metal ions reactive with the gelling agent, thereby forming a secondary mixture.

A preferred process also comprises introducing a solution of soluble multivalent metal ions reactive with the gelling agent to the secondary mixture, thereby forming a tertiary mixture, shaping the tertiary mixture into pre-formed pieces, and tumbling the pre-formed pieces to form the texturized pieces.

Another preferred embodiment of a system for forming texturized pieces of a meat or meat-analog product comprises a first mixer for receiving animal protein, vegetable protein, or a mixture thereof, and a gelling agent, a sequestrant, and water and producing an initial mixture comprising same. A preferred embodiment of a system also comprises a second mixer mechanically coupled to the first mixer for receiving the initial mixture, mixing the initial mixture with a sparingly soluble source of multivalent metal ions reactive with the gelling agent, and producing a secondary mixture comprising same.

A preferred embodiment of a system further comprises an injector mechanically coupled to a second mixer for receiving the secondary mixture, introducing a solution of soluble multivalent metal ions reactive with the gelling agent to the secondary mixture, and producing a tertiary mixture comprising same. A preferred embodiment of a system also comprises a texturizer-separator tumbling pre-formed pieces formed from the tertiary mixture thereby forming the texturized pieces.

Another preferred process for forming texturized pieces of a meat or meat-analog product comprises shaping a mixture of animal protein, vegetable protein, or a mixture thereof, a gelling agent, a sequestrant, water, a sparingly soluble source of multivalent metal ions reactive with the gelling agent, and a solution of soluble multivalent metal ions reactive with the gelling agent into pre-formed pieces, and tumbling the pre-formed pieces to form the texturized pieces.

Another preferred process for forming texturized pieces of a meat or meat-analog product comprises mixing animal protein, vegetable protein, or a mixture thereof with a gelling agent and water, thereby forming an initial mixture. A preferred process also comprises mixing the initial mixture with a sparingly soluble source of multivalent metal ions reactive with the gelling agent, thereby forming a secondary mixture, and introducing a solution of soluble multivalent metal ions reactive with the gelling agent to the secondary mixture, thereby forming a tertiary mixture. A preferred process further comprises shaping the tertiary mixture into pre-formed pieces, and tumbling the pre-formed pieces to form the texturized pieces.

A preferred embodiment of a system for forming texturized pieces of a meat or meat-analog product comprises a first mixer for receiving animal protein, vegetable protein, or a mixture thereof, and a gelling agent and water and producing an initial mixture comprising same. A preferred embodiment also comprises a second mixer mechanically coupled to the first mixer for receiving the initial mixture, mixing the initial mixture with a sparingly soluble source of multivalent metal ions reactive with the gelling agent, and producing a secondary mixture comprising same.

A preferred embodiment further comprises an injector mechanically coupled to the second mixer for receiving the secondary mixture, introducing a solution of soluble multivalent metal ions reactive with the gelling agent to the secondary mixture, and producing a tertiary mixture comprising same. A preferred embodiment also comprises a texturizer-separator for tumbling pre-formed pieces formed from the tertiary mixture thereby forming the texturized pieces.

A preferred process for forming texturized pieces of a meat or meat-analog product comprises shaping a mixture of animal protein, vegetable protein, or a mixture thereof, a gelling agent, water, a sparingly soluble source of multivalent metal ions reactive with the gelling agent, and a solution of soluble multivalent metal ions reactive with the gelling agent into pre-formed pieces, and tumbling the pre-formed pieces to form the texturized pieces.

A preferred process for forming texturized pieces of a meat or meat-analog product comprises mixing animal protein, vegetable protein, or a mixture thereof with alginate, sodium tripolyphosphate, and water, thereby forming an initial mixture, and mixing the initial mixture with calcium sulfate, thereby forming a secondary mixture. A preferred process also comprises introducing a calcium-chloride solution to the secondary mixture, thereby forming a tertiary mixture, shaping the tertiary mixture into pre-formed pieces, and at least one of folding, stretching, pulling, and kneading the pre-formed pieces to form the texturized pieces.

A preferred embodiment of a system for forming texturized pieces of a meat or meat-analog product comprises a first mixer for receiving animal protein, vegetable protein, or a mixture thereof, and alginate, sodium tripolyphosphate, and water and producing an initial mixture comprising same. A preferred embodiment also comprises a second mixer mechanically coupled to the first mixer for receiving the initial mixture, mixing the initial mixture with calcium-sulfate, and producing a secondary mixture comprising same;

A preferred embodiment further comprises an injector mechanically coupled to the second mixer for receiving the secondary mixture, introducing a calcium-chloride solution to the secondary mixture, and producing a tertiary mixture comprising same. A preferred embodiment also comprises a texturizer-separator for at least one of folding, stretching, pulling, and kneading pre-formed pieces formed from the tertiary mixture thereby forming the texturized pieces.

### BRIEF DESCRIPTION OF THE DRAWINGS

The foregoing summary, as well as the following detailed description of a presently-preferred embodiment, is better understood when read in conjunction with the appended drawings. For the purpose of illustrating the invention, the drawings show a preferred embodiment. The invention is not limited, however, to the specific instrumentalities disclosed in the drawings. In the drawings:

FIG. 1 is a flow diagram depicting a presently-preferred process for forming pieces of meat or meat analogs;

FIG. 2 is a diagrammatic illustration of a system for performing the process depicted in FIG. 1;

FIG. 3 is a diagrammatic side view of an injector of the system shown in FIG. 2;

FIG. 4A is a diagrammatic perspective view of a texturizer-separator of the system shown in FIG. 2;

FIG. 4B is a diagrammatic cutaway view of a drum of the texturizer-separator shown in FIG. 4A;

FIG. 4C is a diagrammatic side view of the texturizer-separator shown in FIGS. 4A and 4B;

FIGS. 5A-5C are diagrammatic side views of a pre-formed piece of meat product falling toward and colliding with an inner drum of the texturizer-separator shown in FIG. 4, and folding as a result of the collision;

FIGS. 6A and 6B are photographic representations of texturized pieces of meat formed in accordance with the preferred process depicted in FIG. 1;

FIG. 7 is a diagrammatic cutaway view of an alternative embodiment of a drum of the texturizer-separator shown in FIGS. 4A-4C; and

FIG. 8 is a diagrammatic side view of an alternative embodiment of the texturizer-separator shown in FIGS. 4A-4C.

### DESCRIPTION OF PREFERRED EMBODIMENTS

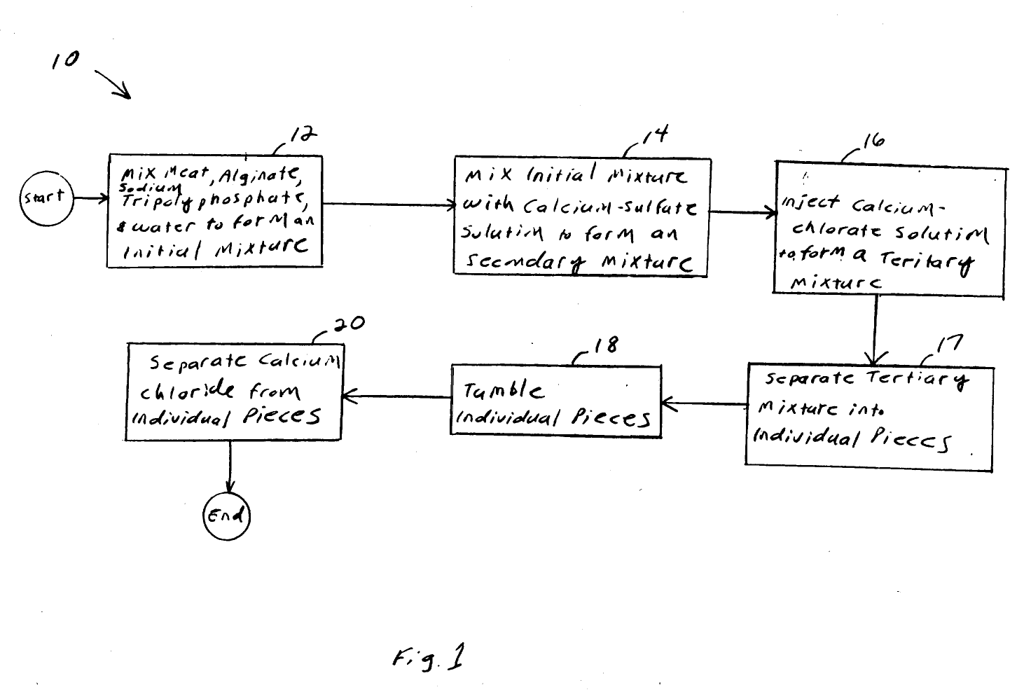

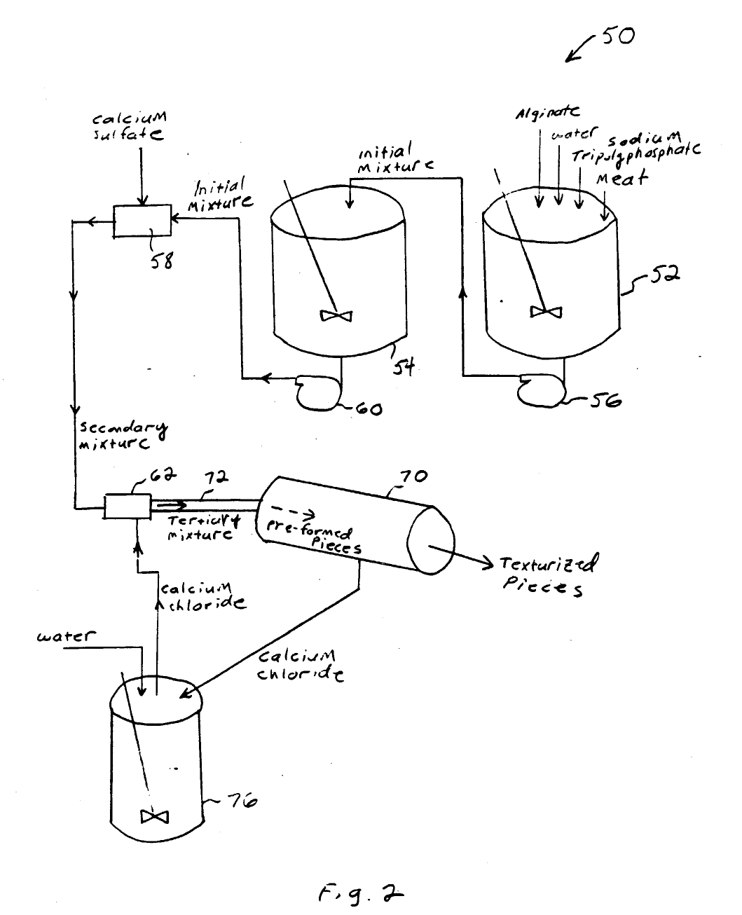

A preferred process 10 for forming pieces of meat or meat analogs having an appearance approximating that of a whole-muscle is depicted in FIG. 1. An exemplary system 50 for conducting the process 10 is depicted in FIG. 2. Specific details relating to the system 50 and its various components are presented herein for exemplary purposes only, as the process 10 can be performed using components other than those described in connection with the system 50.

The process 10, in general, comprises forming a meat product into relatively thin, elongated pieces each having an outer skin, and then tumbling the elongated pieces to form pieces of meat having a whole-muscle-like appearance. Specific details relating to the process 10 are as follows. For simplicity, the term “meat,” as used throughout the specification, is intended to encompass meat products, e.g., chopped, shredded, or ground meat and products containing them, as well as meat-analog products such as soy, wheat gluten, and other vegetable proteins.

The process 10 comprises mixing chopped or finely ground meat with alginate, sodium tripolyphosphate, calcium sulfate, and water. This composition is selected for illustration and is not intended to be limiting. One skilled in the art will appreciate that the process can readily be adapted to utilize alternative meat or meat-analog compositions which comprise a gelling agent (such as alginate), a sequestrant (such as sodium tripolyphosphate), and a sparingly soluble source of multivalent metal ions reactive with the gelling agent (such as calcium sulphate). (The optimal value or range of values for the solubility of the sparingly soluble source of multivalent metal ions will vary with the particular type of multivalent metal ion. A value or range of values for this parameter therefore is not specified herein.) Representative mixing proportions are as follows:

| | Approximate Range |
|---|---|
| Ingredient | (by weight) |
| Meat | 12%-95% |
| Alginate | 0.5%-12% |
| Sodium Tripolyphosphate | 0.01%-1.0% |
| Calcium sulfate | 1%-10% |
| Water | Balance |

A suitable alginate may be obtained, for example, from the FMC Biopolymer Division of FMC Corporation, under the brand name PROTANAL LF®. The alginate (preferably in powder form), sodium tripolyphosphate, and water are initially mixed with the meat in a conventional high-shear mixer 52 to form an initial mixture (this activity is denoted as activity 12 in FIG. 1). A suitable high-shear mixer can be obtained, for example, from Karl Schnell Inc. as model no. B22. The individual components of the initial mixture can be mixed simultaneously, thereby permitting the process 10 to proceed on an on-line basis. Alternatively, the alginate, sodium tripolyphosphate, and water can be mixed, and the meat can be added and mixed on a subsequent basis. (It should be noted that the term “water,” as used throughout the specification and claims, is intended to encompass all type of aqueous solutions, e.g., brine.)

The initial mixture is transferred to a surge tank 54 by a pump 56. The initial mixture is then transferred from the surge tank 54 to a conventional dry mixer 58 by a pump 60. A suitable dry mixer can be obtained, for example, from Autocon Automated Processing, Inc. as the OHD/DID continuous slurry/powder mixer.

The calcium sulfate, in powder form, is added to and mixed with the initial mixture in the dry mixer 58, thereby forming a secondary mixture (activity 14). The use of the surge tank 54 facilitates a continuous flow of the initial mixture to the dry mixer 58, and thus allows the calcium sulfate to be introduced on an in-line basis.

The alginate is believed to act as a gelling agent. The sodium tripolyphosphate is believed to moderate (slow) the gelling of the alginate, e.g., with calcium ions, so that additional processing can be completed before the alginate is fully gelled. Preferably, a sparingly soluble salt such as calcium sulfate is used as a source of multivalent metal ions in the secondary mixture. The reaction rate to gel alginate, as is commonly known by those skilled in the art, can be modified by the use of a mixture of soluble and insoluble salts or sequestrants. Soluble multivalent metal salt, such as calcium chloride, and a seuestrant, or a minor portion of a multivalent soluble salt in the absence of a sequestrant, can be incorporated into the secondary mixture during the process 10 as suitable alternative sources for the multivalent ions to gel the alginate, provided the secondary mixture remains injectable and takes on a whole-muscle-like texture by retaining the creases and fold-lines on the interior of the formed pieces shaped and tumble according to the process 10.

It should be noted that, although the use of a sequestrant such as sodium tripolyphosphate is preferred, the process 10 can be conducted without the use of a sequestrant.

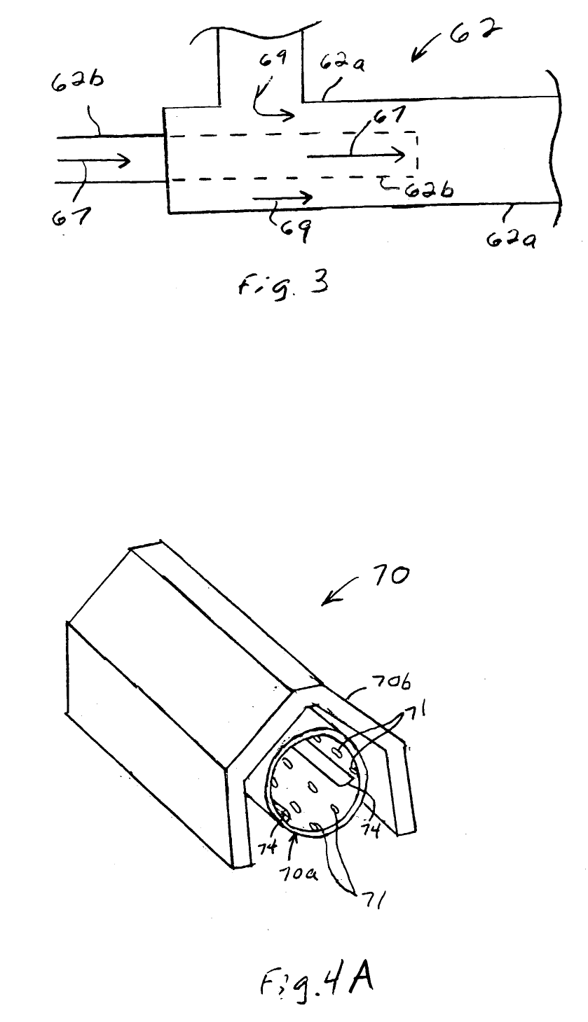

The secondary mixture is transferred to an injector 62 upon leaving the dry mixer 58. The injector 62 mixes the secondary mixture with calcium-chloride solution (activity 16). The injector 62 preferably comprises a substantially T-shaped outer tube 62a, and a substantially straight inner tube 62b partially disposed within the outer tube (see FIG. 3). The diameters of the outer and inner tubes 62a, 62b are, for example, approximately two inches and approximately one inch, respectively. (It should be noted that specific values for the outer and inner diameters are presented for exemplary purposes only, as these values will vary by application.)

The inner tube 62b depicted in FIG. 3 is coupled to the dry mixer 58, and thus receives the secondary mixture from the dry mixer 58. The outer tube 62a receives the calcium-chloride solution from a holding tank 76. (The directions of travel of the secondary mixture and the calcium-chloride solution are denoted respectively by the arrows 67 and the arrows 69 in FIG. 3.) The inner tube 62b extends only partially into the outer tube 62a, as exemplified in FIG. 3. Hence, the inner tube 62b discharges the secondary mixture into the radially-innermost portion of the outer tube 62a, i.e., into the portion of the outer tube 62a located at or near the centerline thereof. The flow pattern downstream of the inner tube 62b is thus believed to be formed substantially by an outer (peripheral) flow of calcium-chloride solution and an inner (core) flow of the secondary mixture. The significance of this feature is discussed below.

The injector 62 facilitates introduction of the calcium-chloride solution on an in-line basis. The calcium-chloride solution may be, for example, a five-percent calcium-chloride solution introduced at a ratio of approximately 1:1 to approximately 2:1, by volumetric flow rate, in relation to the secondary mixture. Alternatively, the calcium-chloride solution may be introduced by immersing the secondary mixture in a bath of calcium-chloride solution for a predetermined period, e.g., three minutes.

The calcium-chloride solution causes a localized gelling of the secondary mixture. More particularly, the interaction between the alginate in the secondary mixture and the calcium-chloride solution is believed to accelerate gelling of the portion of the secondary mixture that comes into contact with the calcium-chloride solution.

The injector 62 introduces the calcium-chloride solution in a manner that is believed to cause the calcium-chloride solution to form an outer layer over the secondary mixture as the calcium-chloride solution and the secondary mixture travel through the outer tube 62a of the injector 62, as noted above. Hence, the outer portion of the secondary mixture, i.e., the portion of the secondary mixture exposed to the highest concentration of calcium-chloride solution, is believed to gel due to the interaction between the alginate in the secondary mixture and the calcium-chloride solution. (The “outer portion” of the secondary mixture can also be conceptualized as the portion of the secondary mixture located closest to the inner surface of the outer tube 62a.) The gelled outer portion of the secondary mixture acts as an “outer skin” around the comparatively soft interior portion of the secondary mixture.

The calcium-chloride solution, as noted above, accelerates the gelling of the outer portion of the secondary mixture. The interior portion of the secondary mixture, i.e., the portion of the secondary mixture located radially inward of the outer portion, is believed to gel primarily due to the calcium ions from the calcium sulphate added to the secondary mixture. The exposure of the interior portion to the calcium-chloride solution is minimal, thereby leading to a slower gelling rate in the interior portion in comparison to the outer portion.

It should be noted that the use of calcium-chloride solution is described for exemplary purposes only. Virtually any type of solution of soluble multivalent metal ions reactive with the gelling agent can be used in lieu of the calcium-chloride solution.

A tertiary mixture formed by introducing the calcium-chloride solution to the secondary mixture in the injector 62 flows into a transfer tube 72 upon exiting the injector 62. (It should be noted that the calcium-chloride solution and the secondary mixture do not fully mix in the injector 62. Rather, the calcium-chloride solution is believed to react primarily with the outer portion of the secondary mixture as, and after, the secondary mixture exits the inner tube 62b of the injector 62, as explained above.)

The tertiary mixture is not fully gelled as it exits the injector 62 and travels through the transfer tube 72. More particularly, the interior portion of the tertiary mixture, which has not been substantially exposed to the calcium-chloride solution, is not substantially gelled at this point in the process 10. The tertiary mixture thus separates into discrete lengths of material, hereinafter referred to as “pre-formed pieces,” as the tertiary mixture is discharged from the injector 62 and travels through the transfer tube 72. This separation occurs because the internal gel strength within the tertiary mixture is not yet sufficient to withstand the mechanical forces acting on the relatively long piece of tertiary mixture formed in the injector 62.

It should be noted that flow conditions of the secondary mixture and the calcium-chloride solution in the injector 62, i.e., the flow-rate, linear velocity, Reynolds number, etc., are preferably set so that minimal turbulence occurs in the secondary mixture and the calcium-chloride solution. Minimal turbulence inhibits substantial mixing of the secondary mixture and the calcium-chloride solution, thereby facilitating gelling of the outer portion of the secondary mixture and formation of the outer skin. Moreover, minimal turbulence encourages the secondary mixture to remain a continuous or semi-continuous length of material as it travels through the injector 62, further promoting formation of the outer skin. (It is believed that satisfactory results can be achieved when relatively high turbulence is present in the injector 62; however, more favorable results, i.e., an end product having a texture that more closely approximates that of a whole-muscle product, can be achieved when relatively low turbulence is present in the injector 62.)

The pre-formed pieces enter a texturizer-separator 70 upon exiting the transfer tube 72 (activity 17). Each pre-formed piece has a substantially cylindrical shape as it exits the transfer tube 72, due to the circular cross-sections of the transfer tube 72 and the outer tube 62a. Moreover, each pre-formed piece has the gelled outer skin believed to be formed by the interaction between the calcium-chloride solution and the alginate in the secondary mixture.

The firmness of the outer skin on each pre-formed piece in relation to the firmness of the interior portion thereof is believed to be proportionate to the amount of time the alginate in the pre-formed piece is in contact with the calcium-chloride solution. Hence, the relative firmness of the outer skin is believed to be proportionate to the residence time of the pre-formed pieces in the transfer tube 72.

The texturizer-separator 70 tumbles the pre-formed pieces (activity 18), and thereby causes the pre-formed pieces to fold. Applicants have found that this folding action introduces fold lines and creases that create an appearance similar to that of a whole-muscle meat product.

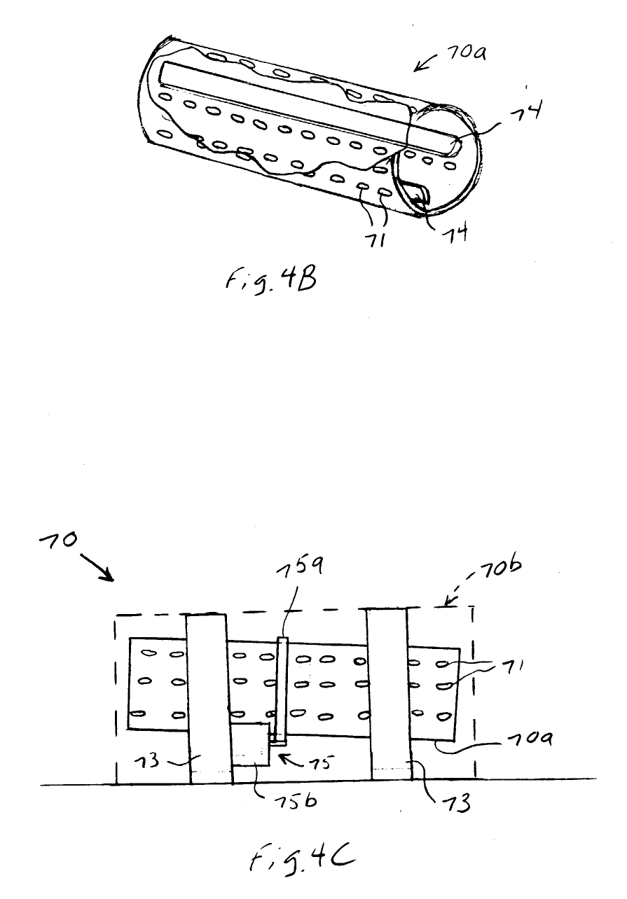

The texturizer-separator 70 comprises a drum 70a (see FIGS. 4A-4C). The texturizer-separator 70 also comprises a stationary support structure 70b (the support structure 70b is shown in phantom in FIG. 4C, for clarity). The drum 70a is rotatably coupled to the support structure 70b. The drum 70a can be coupled to the support structure 70b by, for example, a first and second collar 73 (see FIG. 4C). The first and second collar 73 can comprise bearings (not shown) that facilitate rotation of the drum 70a.

The texturizer-separator 70 also comprises a drive mechanism 75 for rotating the drum 70a within a predetermined range of rotational speeds (see FIG. 4C). The drive mechanism 75 can comprise, for example, a gear ring 75a secured to an outer surface of the drum 70a, and an electrical motor and controller unit 75b for driving the gear ring 75a.

The drum 70a preferably has a plurality of perforations 71 formed therein, as shown in FIGS. 4A-4C. The function of the perforations 71 is discussed below. (Alternatively, the drum 70a can be formed as a cylindrically-shaped screen supported by an appropriate framework.)

The texturizer-separator 70 further comprises a plurality of flights 74. The flights 74 are fixedly coupled to an inner surface of the drum 70a, and preferably extend over substantially the entire length of the drum 70a (see FIG. 4B). Moreover, a second perforated or screened drum may be positioned around and fixedly coupled to the drum 70a in alternative embodiments.

The transfer tube 72 deposits the pre-formed pieces at or near an input, or upstream end of the drum 70a. The drum 70a is inclined in relation to the support structure 70b so that the upstream end of the drum 70a is positioned at a higher elevation than an output, or downstream end thereof (see FIG. 4C). The inclination of the drum 70a causes the pre-formed pieces to travel toward the downstream end of the drum 70a. The texturizer-separator 70 is preferably configured so that the angle of inclination thereof can be adjusted within a predetermined range of values.

The flights 74, which rotate with the drum 70a, contact and lift the pre-formed pieces as the pre-formed pieces travel between the upstream and downstream ends of the drum 70a. The pre-formed pieces eventually fall off the flights 74 as the flights 74 approach the top of their respective rotational paths. It should be noted that other means can be used to achieve the function provided by the flights 74. In particular, virtually any means capable of inducing a lifting action or preventing slippage between the drum 70a and the pre-formed pieces, e.g., a rough surface on the drum 70a, can be used in lieu of the flights 74.

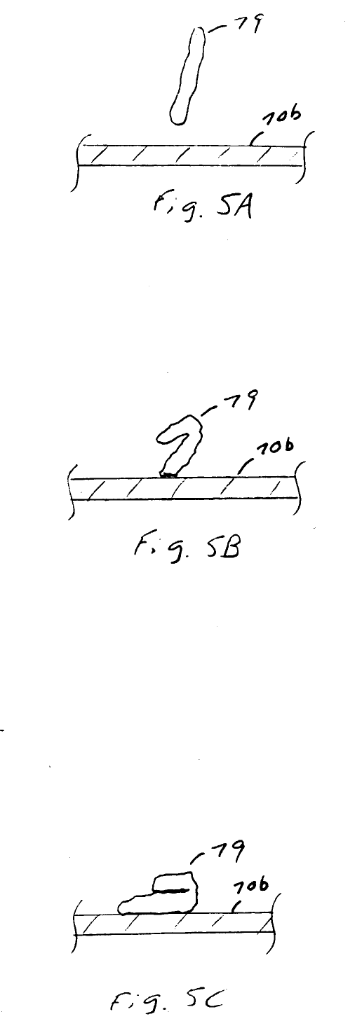

The resulting impacts between the pre-formed pieces and the lower portions of the drum 70a cause the pre-formed pieces to fold, as depicted in FIGS. 5A-5C. In particular, FIGS. 5A-5C depict a single pre-formed piece 79 colliding with the drum 70a and folding as a result of the collision.

The folding of each pre-formed piece is related to the relative firmness of the outer skin and the interior portion of the pre-formed piece. The firmness of the outer skin and the interior are related to the proportions of the various constituent elements of the pre-formed piece. For example, increasing the relative proportion of sodium tripolyphosphate will generally decrease the firmness of the interior portion in relation to the outer skin. The relative firmness of the outer skin is also related to the time over which the secondary and tertiary mixtures are exposed to the calcium-chloride solution.

The outer skin must have sufficient strength in relation of the interior portion to prevent the outer skin from rupturing excessively during the tumbling operation. The outer skin and the interior portion must be sufficiently pliable, however, to permit the pre-formed piece to fold and thereby take on an appearance similar to that of a whole-muscle meat product.

Each pre-formed piece may be lifted, dropped, and folded several times as it travels through the drum 70a. Applicants have found that the additional fold lines and creases caused by folding the pre-formed pieces several times enhance the texturized appearance thereof. Moreover, the pre-formed pieces fold at random locations thereon, further enhancing the texturized appearance thereof. (Pre-formed pieces having a relatively long length may break into smaller pieces in the texturizer-separator 70 due to the tumbling action therein.)

The texturizer-separator 70 also separates the calcium-chloride solution from the pre-formed pieces (activity 20). More specifically, the tumbling of the pre-formed pieces causes a substantial portion of the calcium-chloride solution added in the injector 62 to drain from the pre-formed pieces. The perforations 71 in the drum 70a permit the calcium-chloride solution to drain from the drum 70a. The calcium-chloride solution is subsequently recycled, i.e., the calcium-chloride solution is routed from the collection basin to the holding tank 76 for subsequent reuse in the injector 62 (see FIG. 2).

Alternative embodiments may incorporate screening across the perforation 71 to reduce the amount of particulate matter routed to the holding tank 76 with the calcium-chloride solution. Moreover, alternative embodiments may separate the calcium-chloride solution from the pre-formed pieces by passing the pre-formed pieces over a vibrating screen after the pre-formed pieces have been texturized.

The texturizer-separator 70 tumbles the pre-formed pieces (activity 18) and thereby causes the pre-formed pieces to fold, as noted above. The resulting fold lines and creases create a texturized appearance similar to that of a whole-muscle meat product. The pieces leaving the texturizer-separator 70 represent the final form of the product produced by the process 10, and are hereinafter referred to as “texturized pieces.”

The texturized pieces, after leaving the texturizer-separator 70, are allowed to set for a predetermined period of time to allow the internal portion of each texturized piece to more fully gel. The fold lines and creases introduced by the tumbling process become permanently set into each texturized piece as the internal portion of the texturized piece fully gels. The texturized pieces can subsequently undergo further processing operations well known to those skilled in the art, e.g., flavoring, coloring, packaging, etc.

The texturizer-separator 70 transforms the pre-formed pieces into texturized pieces of meat having an appearance approximating that of a whole-muscle meat product. The whole-muscle-like appearance, as previously noted, is a result of Applicants' discovery that tumbling the pre-formed pieces causes the pre-formed pieces to fold, and to retain the resulting creases and fold lines so that the pre-formed pieces take on the appearance of whole muscle.

The ability of the pre-formed pieces to fold in a satisfactory manner appears to be closely related to the firmness of the outer skin in relation to the interior portion thereof, as noted above. More particularly, excessive firmness of the outer skin tends to inhibit the desired folding action. (The desired folding action can also be inhibited by firmness of the interior portion.) Insufficient strength of the outer skin can result in rupturing of the outer skin as the pre-formed pieces are tumbled.

Rupturing of the outer skin exposes the relatively soft inner portion of each pre-formed piece, and may permit the inner portion to spill or ooze from the outer skin. While some rupturing of the outer skin is generally acceptable, excessive rupturing should be avoided if it results in pieces which are too small to use or have not taken on the desired whole-muscle-like appearance.

The exact proportions of the alginate, sodium tripolyphosphate, calcium sulfate, and water added to the meat product determine the relative firmness of the outer skin and the internal portion of the pre-formed pieces. The relative firmness of the outer skin and the interior portion is also related to the time over which the secondary and tertiary mixtures are exposed to the calcium-chloride solution. The optimal relative firmness of the outer skin and the interior portion, and thus the optimal values for these factors, are related to the mechanics of the tumbling process. In particular, the optimal relative firmness is related to factors such as the rotational speed of the drum 70a, the residence time of the pre-formed pieces in the texturizer-separator 70, the number of times the pre-formed pieces are tumbled, etc.

It should be noted that the thickness of the outer skin is related to the relative firmness thereof. An optimal value for the thickness will therefore vary with the factors that determine the relative firmness of the outer skin. A particular value for the thickness of the outer skin therefore is not specified herein.

The system 10 is equipped with a number of features that permit the mechanics of the tumbling process to be varied. For example, the rotational speed of the drum 70a can be varied within a predetermined range, as previously noted. Moreover, the angle of inclination of the texturizer-separator 70 can also be varied within a predetermined range. This feature allows the residence time of the pre-formed pieces in the texturizer-separator 70 to be optimized.

The residence time of the pre-formed pieces in the texturizer-separator 70 can also be varied by changing the distance that the transfer tube 72 extends down the texturizer-separator 70 from the entrance thereof, thus reducing the length of the drum 70a through which the pre-formed pieces are tumbled. (Conversely, the residence time can be increased by the use of a transfer tube having a shorter reach down the length of the drum 70a.)

The overall length of the transfer tube 72 can be altered while maintaining a constant material flow rate to vary the contact time with the calcium-chloride solution and, consequently, the thickness and firmness of the outer skin. The length of the transfer tube 72 can be altered by replacing a particular transfer tube 72 with another transfer tube having a different length. Alternatively, the transfer tube 72 can be configured so that its length can be adjusted on a selective basis. For example, the transfer tube 72 can be configured so as to telescope down the length of the drum 70a, or the portion of the transfer tube 72 upstream of the drum 70a can be lengthened. These features permit the residence time of the pre-formed pieces in the transfer tube 72 to be adjusted, and thus facilitate control of the external calcium set of the pre-formed pieces.

Moreover, the number, size, or shape of the flights 74 can be varied to increase or decrease the tumbling action. In addition, alternative embodiments may incorporate one or more calcium-chloride sprays in or near the drum 70a to thicken the outer skin of the pre-formed pieces after the pre-formed pieces enter the texturizer-separator 70.

An actual production-scale example of the process 10 can be conducted as follows. Approximately 1.6 kilograms of alginate and approximately 96 grams of sodium tripolyphosphate are mixed with approximately 120 liters of water in the high-shear mixer 52 for approximately two minutes. Approximately 20 kilograms of soy protein are then added and mixed under high shear for approximately two minutes to form an initial mixture. The initial mixture is subsequently pumped to the surge tank 54.

The initial mixture is pumped from the surge tank 54 to the dry mixer 58, where dry calcium sulfate is added to the initial mixture at a rate of approximately two-percent of the initial mixture, by weight. The resulting secondary mixture is subsequently directed to the injector 62 at a flow rate of approximately 16.7 liters per minute. The injector 62 introduces a five-percent calcium-chloride solution at a ratio of approximately 1:1 to approximately 2:1, by volumetric flow rate, in relation to the secondary mixture.

The resulting pre-formed pieces are directed to the texturizer-separator 70 by way of the transfer tube 72. The residence time of the pre-formed pieces in the transfer tube 72 is approximately one to approximately three minutes. The pre-formed pieces typically have a length of approximately one to approximately six inches upon exiting the transfer tube 72. (A pre-formed piece undergoing an actual processing operation performed in this manner was retrieved at the exit of the transfer tube 72 and broken open immediately thereafter. The interior of the pre-formed piece, upon inspection, was found to have a substantially uniform appearance.)

The pre-formed pieces are tumbled in the texturizer-separator 70 for approximately two minutes, with the texturizer-separator 70 operating at a rotational speed of approximately six to approximately ten revolutions per minute. The resulting texturized pieces, upon exiting the texturizer-separator 70, typically have a length of approximately one to approximately three inches, and a length-to-diameter ratio greater than 1:1. (A texturized piece formed by the actual processing operation performed in this manner was retrieved at the exit of the texturizer-separator 70 and broken open after a predetermined residence time. The texturized piece, upon inspection, was found to have an appearance approximating that of a whole-muscle meat product.)

Another production-scale example of the process 10 can be conducted as follows. Approximately 1.6 kilograms of alginate and approximately 160 grams of sodium tripolyphosphate are mixed with approximately 75 liters of water in the high-shear mixer 52 for approximately two minutes. Approximately 80 kilograms of finely-ground meat are then added and mixed under high shear for approximately two minutes to form an initial mixture. The initial mixture is subsequently pumped to the surge tank 54.

The initial mixture is pumped from the surge tank 54 to the dry mixer 58, where dry calcium sulfate is added to the initial mixture at a rate of approximately two-percent of the initial mixture, by weight. The resulting secondary mixture is subsequently directed to the injector 62 at a flow rate of approximately 16.7 liters per minute. The injector 62 introduces a five-percent calcium-chloride solution at a ratio of approximately 1:1 to approximately 2:1, by volumetric flow rate, in relation to the secondary mixture.

The resulting pre-formed pieces are directed to the texturizer-separator 70 by way of the transfer tube 72. The residence time of the pre-formed pieces in the transfer tube 72 is approximately one to approximately three minutes. The pre-formed pieces typically have a length of approximately one to approximately six inches upon exiting the transfer tube 72. (A texturized piece undergoing an actual processing operation performed in this manner was retrieved at the exit of the transfer tube 72 and broken open immediately thereafter. The interior of the pre-formed piece, upon inspection, was found to have a substantially uniform appearance.)

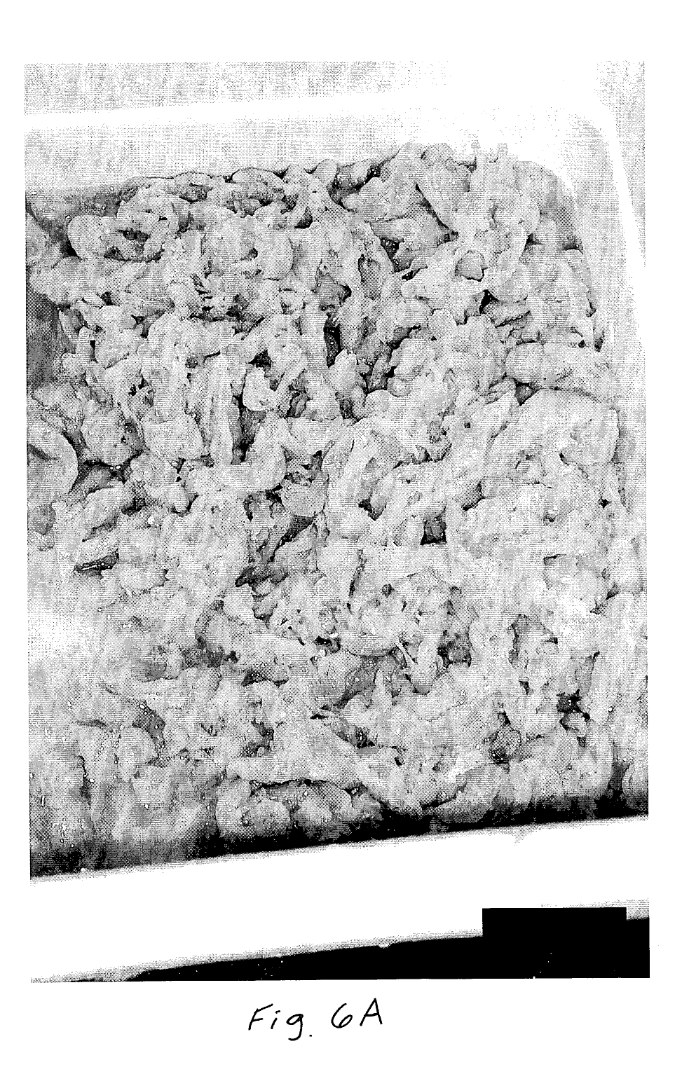

The pre-formed pieces are tumbled in the texturizer-separator 70 for approximately two minutes, with the texturizer-separator 70 operating at a rotational speed of approximately six to approximately ten revolutions per minute. The resulting texturized pieces, upon exiting the texturizer-separator 70, typically have a length of approximately one to approximately three inches, and a length-to-diameter ratio greater than 1:1. FIGS. 6A and 6B are photographic representations showing texturized pieces formed using this particular example of the process 10.

It is to be understood that even though numerous characteristics and advantages of the present invention have been set forth in the foregoing description, the disclosure is illustrative only and changes may be made in detail within the principles of the invention to the full extent indicated by the broad general meaning of the terms in which the appended claims are expressed.

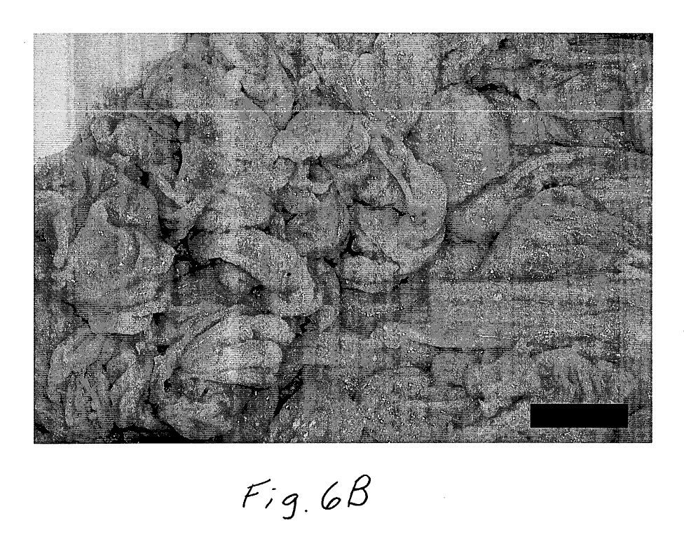

For example, FIG. 7 depicts an alternative embodiment of the drum 70a. In particular, FIG. 7 depicts a drum 100 that can be used in the texturizer-separator 70 in place of the drum 70a. The drum 100 has a plurality of rod-shaped fingers 102 fixedly coupled to an inner surface thereof. The fingers 102 can have uniform or, alternatively, non-uniform dimensions with respect to each other, and are preferably distributed over substantially the entire length of the drum 100. The fingers 102 cause the pre-formed pieces to be folded, stretched, pulled, and kneaded as the pre-formed pieces travel between the upstream and downstream ends of the drum 100. The fingers 102 can be used with or without the flights 74 described above in relation to the drum 70a.

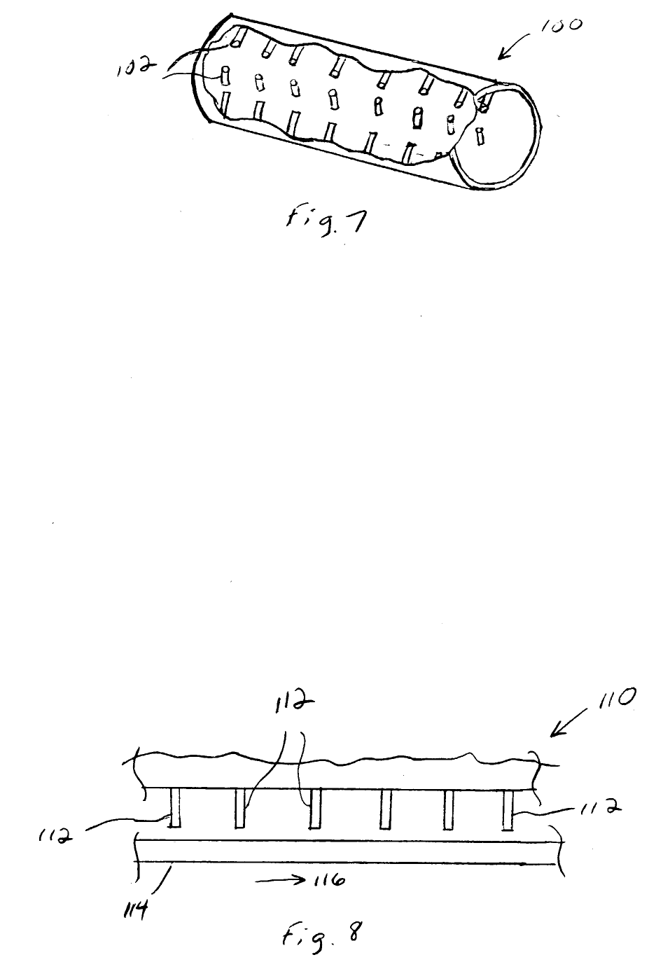

FIG. 8 depicts another alternative embodiment of the texturizer-separator 70. In particular, FIG. 8 depicts a texturizer-separator 110 comprising a plurality of stationary fingers 112 substantially similar to the fingers 102. The texturizer-separator 110 also comprises a conveyor 114. The conveyor 114 comprises a moving belt that transports the pre-formed pieces past the fingers 112 (in the direction denoted by the arrow 116), and thereby causes the pre-formed pieces to be folded, stretched, pulled, and kneaded by the fingers 112.

What is claimed:

1. A process for forming texturized pieces of a meat or meat-analog product, comprising:
mixing animal protein, vegetable protein, or a mixture thereof with alginate, sodium tripolyphosphate, and water, thereby forming an initial mixture;
mixing the initial mixture with calcium sulfate, thereby forming a secondary mixture;
introducing a calcium-chloride solution to the secondary mixture, thereby forming a tertiary mixture;
shaping the tertiary mixture into pre-formed pieces; and
tumbling the pre-formed pieces to form the texturized pieces.

2. The process of claim 1, further comprising separating at least a portion of the calcium-chloride solution from the pre-formed pieces.

3. The process of claim 1, wherein the initial mixture comprises, by weight:
approximately 12% to approximately 95% of the protein;
approximately 0.5% to approximately 12% of the alginate;
approximately 0.01% to approximately 1.0% of the sodium tripolyphosphate;
approximately 1.0% to approximately 10% of the calcium sulfate; and
a balance comprising the water.

4. The process of claim 1, further comprising spraying the calcium-chloride solution on the pre-formed pieces as the pre-formed pieces are tumbled.

5. The process of claim 1, wherein tumbling the pre-formed pieces to form the texturized pieces comprises lifting the pre-formed pieces and causing the pre-formed pieces to fall.

6. The process of claim 1, wherein tumbling the pre-formed pieces to form the texturized pieces comprises lifting the pre-formed pieces using a flight fixedly coupled to an inner surface of a rotating drum, and causing the pre-formed pieces to fall and collide with the inner surface.

7. A system for forming texturized pieces of a meat or meat-analog product, comprising:
a first mixer for receiving animal protein, vegetable protein, or a mixture thereof, and alginate, sodium tripolyphosphate, and water and producing an initial mixture comprising same;
a second mixer mechanically coupled to the first mixer for receiving the initial mixture, mixing the initial mixture with calcium-sulfate, and producing a secondary mixture comprising same;
an injector mechanically coupled to the second mixer for receiving the secondary mixture, introducing a calcium-chloride solution to the secondary mixture, and producing a tertiary mixture comprising same; and
a texturizer-separator for tumbling pre-formed pieces formed from the tertiary mixture thereby forming the texturized pieces.

8. The system of claim 7, wherein the texturizer-separator separates at least a portion of the calcium-chloride solution from the pre-formed pieces.

9. The system of claim 7, wherein the texturizer-separator comprises a rotating drum.

10. The system of claim 9, wherein the texturizer-separator further comprises a stationary support structure and the drum is rotatably coupled to the support structure.

11. The system of claim 10, wherein the texturizer-separator further comprises a collar and the drum is rotatably coupled to the support structure by way of the collar.

12. The system of claim 9, wherein the texturizer-separator further comprises a drive mechanism for rotating the drum.

13. The system of claim 12, wherein the drive mechanism comprises a gear ring fixedly coupled to an outer surface of the drum, and an electrical motor and control unit for driving the gear ring.

14. The system of claim 9, wherein the texturizer-separator further comprises a plurality of flights fixedly coupled to an inner surface of the drum.

15. The system of claim 14, wherein the flights extend over substantially an entire length of the drum.

16. The system of claim 9, wherein the drum has a plurality of perforations formed therein.

17. The system of claim 9, wherein the texturizer-separator further comprises a plurality of rod-shaped fingers fixedly coupled to an inner surface of the drum.

18. The system of claim 10, wherein the drum is inclined in relation to the support structure so that a first end of the drum is positioned at a higher elevation than a second end of the drum.

19. The system of claim 7, wherein the first mixer is a high-shear mixer.

20. The system of claim 7, wherein the second mixer is a dry mixer.

21. The system of claim 7, wherein the injector comprises a substantially T-shaped outer tube and a substantially straight inner tube partially disposed within the outer tube.

22. A process, comprising shaping a mixture of animal protein, vegetable protein, or a mixture thereof, and alginate, sodium tripolyphosphate, water, calcium sulfate, and calcium-chloride solution into pre-formed pieces, and tumbling the pre-formed pieces.

23. The process of claim 22, wherein tumbling the pre-formed pieces comprises lifting the pre-formed pieces and causing the pre-formed pieces to fall.

24. The process of claim 22, wherein tumbling the pre-formed pieces comprises lifting the pre-formed pieces using a flight fixedly coupled to an inner surface of a rotating drum, and causing the pre-formed pieces to fall and collide with the inner surface.

25. A process for forming texturized pieces of a meat or meat-analog product, comprising:
mixing animal protein, vegetable protein, or a mixture thereof with a gelling agent, a sequestrant, and water, thereby forming an initial mixture;
mixing the initial mixture with a sparingly soluble source of multivalent metal ions reactive with the gelling agent, thereby forming a secondary mixture;
introducing a solution of soluble multivalent metal ions reactive with the gelling agent to the secondary mixture, thereby forming a tertiary mixture;
shaping the tertiary mixture into pre-formed pieces; and
tumbling the pre-formed pieces to form the texturized pieces.

26. The process of claim 25, further comprising separating at least a portion of the calcium-chloride solution from the pre-formed pieces.

27. The process of claim 25, wherein the initial mixture comprises, by weight:
approximately 12% to approximately 95% of the protein;
approximately 0.5% to approximately 12% of the gelling agent;
approximately 0.01% to approximately 1.0% of the sequestrant;
approximately 1.0% to approximately 10% of the sparingly soluble source of multivalent metal ions; and
a balance comprising the water.

28. The process of claim 25, further comprising spraying the solution of soluble multivalent metal ions on the pre-formed pieces as the pre-formed pieces are tumbled.

29. The process of claim 25, wherein tumbling the pre-formed pieces to form the texturized pieces comprises lifting the pre-formed pieces and causing the pre-formed pieces to fall.

30. The process of claim 25, wherein tumbling the pre-formed pieces to form the texturized pieces comprises lifting the pre-formed pieces using a flight fixedly coupled to an inner surface of a rotating drum, and causing the pre-formed pieces to fall and collide with the inner surface.

31. A system for forming texturized pieces of a meat or meat-analog product, comprising:
a first mixer for receiving animal protein, vegetable protein, or a mixture thereof, and a gelling agent, a sequestrant, and water and producing an initial mixture comprising same;
a second mixer mechanically coupled to the first mixer for receiving the initial mixture, mixing the initial mixture with a sparingly soluble source of multivalent metal ions reactive with the gelling agent, and producing a secondary mixture comprising same;
an injector mechanically coupled to a second mixer for receiving the secondary mixture, introducing a solution of soluble multivalent metal ions reactive with the gelling agent to the secondary mixture, and producing a tertiary mixture comprising same; and
a texturizer-separator for tumbling pre-formed pieces formed from the tertiary mixture thereby forming the texturized pieces.

32. A process for forming texturized pieces of a meat or meat-analog product, comprising shaping a mixture of animal protein, vegetable protein, or a mixture thereof, a gelling agent, a sequestrant, water, a sparingly soluble source of multivalent metal ions reactive with the gelling agent, and a solution of soluble multivalent metal ions reactive with the gelling agent into pre-formed pieces, and tumbling the pre-formed pieces to form the texturized pieces.

33. The process of claim 32, wherein tumbling the pre-formed pieces to form the texturized pieces comprises lifting the pre-formed pieces and causing the pre-formed pieces to fall.

34. The process of claim 32, wherein tumbling the pre-formed pieces to form the texturized pieces comprises lifting the pre-formed pieces using a flight fixedly coupled to an inner surface of a rotating drum, and causing the pre-formed pieces to fall and collide with the inner surface.

35. A process for forming texturized pieces of a meat or meat-analog product, comprising:
mixing animal protein, vegetable protein, or a mixture thereof with a gelling agent and water, thereby forming an initial mixture;
mixing the initial mixture with a sparingly soluble source of multivalent metal ions reactive with the gelling agent, thereby forming a secondary mixture;
introducing a solution of soluble multivalent metal ions reactive with the gelling agent to the secondary mixture, thereby forming a tertiary mixture;
shaping the tertiary mixture into pre-formed pieces; and
tumbling the pre-formed pieces to form the texturized pieces.

36. The process of claim 35, wherein tumbling the pre-formed pieces to form the texturized pieces comprises lifting the pre-formed pieces and causing the pre-formed pieces to fall.

37. The process of claim 35, wherein tumbling the pre-formed pieces to form the texturized pieces comprises lifting the pre-formed pieces using a flight fixedly coupled to an inner surface of a rotating drum, and causing the pre-formed pieces to fall and collide with the inner surface.

38. A system for forming texturized pieces of a meat or meat-analog product, comprising:
a first mixer for receiving animal protein, vegetable protein, or a mixture thereof, and a gelling agent and water and producing an initial mixture comprising same;
a second mixer mechanically coupled to the first mixer for receiving the initial mixture, mixing the initial mixture with a sparingly soluble source of multivalent metal ions reactive with the gelling agent, and producing a secondary mixture comprising same;
an injector mechanically coupled to the second mixer for receiving the secondary mixture, introducing a solution of soluble multivalent metal ions reactive with the gelling agent to the secondary mixture, and producing a tertiary mixture comprising same; and
a texturizer-separator for tumbling pre-formed pieces formed from the tertiary mixture thereby forming the texturized pieces.

39. A process for forming texturized pieces of a meat or meat-analog product, comprising shaping a mixture of animal protein, vegetable protein, or a mixture thereof, a gelling agent, water, a sparingly soluble source of multivalent metal ions reactive with the gelling agent, and a solution of soluble multivalent metal ions reactive with the gelling agent into pre-formed pieces, and tumbling the pre-formed pieces to form the texturized pieces.

40. The process of claim 39, wherein tumbling the pre-formed pieces to form the texturized pieces comprises lifting the pre-formed pieces and causing the pre-formed pieces to fall.

41. The process of claim 39, wherein tumbling the pre-formed pieces to form the texturized pieces comprises lifting the pre-formed pieces using a flight fixedly coupled to an inner surface of a rotating drum, and causing the pre-formed pieces to fall and collide with the inner surface.

42. A texturized piece of meat or meat-analog product formed in accordance with the process of claim 1.

43. A texturized piece of meat or meat-analog product formed in accordance with the process of claim 25.

44. A texturized piece of meat or meat-analog product formed in accordance with the process of claim 35.

45. A process for forming texturized pieces of a meat or meat-analog product, comprising:
mixing animal protein, vegetable protein, or a mixture thereof with alginate, sodium tripolyphosphate, and water, thereby forming an initial mixture;
mixing the initial mixture with calcium sulfate, thereby forming a secondary mixture;
introducing a calcium-chloride solution to the secondary mixture, thereby forming a tertiary mixture;
shaping the tertiary mixture into pre-formed pieces; and
at least one of folding, stretching, pulling, and kneading the pre-formed pieces to form the texturized pieces.

46. A system for forming texturized pieces of a meat or meat-analog product, comprising:
a first mixer for receiving animal protein, vegetable protein, or a mixture thereof, and alginate, sodium tripolyphosphate, and water and producing an initial mixture comprising same;
a second mixer mechanically coupled to the first mixer for receiving the initial mixture, mixing the initial mixture with calcium-sulfate, and producing a secondary mixture comprising same;
an injector mechanically coupled to the second mixer for receiving the secondary mixture, introducing a calcium-chloride solution to the secondary mixture, and producing a tertiary mixture comprising same; and
a texturizer-separator for at least one of folding, stretching, pulling, and kneading pre-formed pieces formed from the tertiary mixture thereby forming the texturized pieces.

47. The system of claim 46, wherein the texturizer-separator comprises a plurality of rod-shaped fingers, and a conveyor for causing the pre-formed pieces to contact the fingers.
